(19) United States
(12) Patent Application Publication
(10) Pub. No.: US 2024/0262506 A1
(43) Pub. Date: Aug. 8, 2024

(54) GALLEY SYSTEM

(71) Applicant: B/E AEROSPACE, INC., Winston Salem, NC (US)

(72) Inventors: Louie Manarang Perez, Tanauan (PH); John Ervin Epan Albina, Santo Tomas (PH); Marc Medina Marges, Santo Tomas (PH); Glenn Ugalde Pillado, Tanauan City (PH); John Oliver Falcutila Mongis, Tanauan (PH)

(73) Assignee: B/E AEROSPACE, INC., Winston Salem, NC (US)

(21) Appl. No.: 18/428,362

(22) Filed: Jan. 31, 2024

(30) Foreign Application Priority Data
Feb. 2, 2023 (EP) 23154785.2

(51) Int. Cl. B64D 11/04; E05B 47/00; E05B 65/00

(52) U.S. Cl. CPC B64D 11/04; E05B 47/0002; E05B 47/0012; E05B 65/00; E05B 2047/0017; E05B 2047/002; E05B 2047/0067

(57) ABSTRACT

A locking arrangement for an aircraft galley system comprises a sensor and a controller, wherein the sensor is configured to determine when a galley insert has been received by a galley assembly and the controller is configured to control a lock to lock the galley insert to the galley assembly in response to the galley insert being received by the galley assembly.

### CROSS-REFERENCE TO RELATED APPLICATIONS

This application claims priority to, and the benefit of, EP Patent Application No. 23154785.2, filed Feb. 2, 2023 and titled “GALLEY SYSTEM,” which is incorporated by reference herein in its entirety for all purposes.

### FIELD

The present invention relates to a locking arrangement for an aircraft galley system, a galley insert, a locking system and a galley system.

### BACKGROUND

Galley systems in aircraft include galley inserts (e.g. cooking appliances) which are removed from a galley for maintenance or replacement. During flight the galley insert is locked to the galley by locking arrangements. Existing locking arrangements can be unreliable, potentially leading to damage to the galley insert or injury to personnel in an aircraft cabin.

### SUMMARY

In accordance with a first aspect, there is provided a locking arrangement for an aircraft galley system, the locking arrangement comprising a sensor and a controller, wherein the sensor is configured to determine when a galley insert has been received by a galley assembly and the controller is configured to control a lock to lock the galley insert to the galley assembly in response to the galley insert being received by the galley assembly.

By having a controller which locks the galley insert to the galley assembly in response to the galley insert being received by the galley assembly, the galley insert is more reliably locked to the galley assembly and the possibility of human error in manually locking a galley insert to the galley assembly (e.g. due to a failure to lock the galley insert or due to damage being caused during manual locking) is reduced.

The sensor may comprise a first communicator configured to determine that the first communicator is within proximity of a second communicator to determine that the galley insert has been received by the galley assembly.

The first communicator may be a near-field communication communicator. The first communicator may be an active near-field communication communicator.

The second communicator may be a near-field communication communicator. The second communicator may be a passive near-field communication communicator.

The locking arrangement may comprise the lock. The lock may comprise a pin, the pin movable into a locked position to lock the galley insert to the galley assembly. In the locking position the pin may be received in an aperture to lock the galley insert to the galley assembly.

The lock may comprise an actuator for moving the pin into the locked position. The actuator may be an electromagnetic actuator. The electromagnetic actuator may be a motor. The lock may comprise a gear device for converting rotational movement of the motor to linear movement of the pin.

The locking arrangement may comprise a user controllable element, the user controllable element actuatable to unlock the galley insert from the galley assembly. The user controllable element may be a button.

The controller may be configured to control the lock to unlock the galley insert from the galley assembly.

The actuator may be configured to move the pin from the locked position to an unlocked position to unlock the galley insert from the galley assembly.

The locking arrangement may be comprised in an insert unit. The insert unit may comprise a first connector for connecting the insert unit to a galley insert.

In accordance with a second aspect, there is provided a galley insert comprising the locking arrangement of the first aspect. The galley insert of the second aspect may comprise any of the features of the first aspect.

The galley insert may be a cooking appliance. The cooking appliance may be a beverage maker. The beverage maker may be a coffee machine. The cooking appliance may be an oven e.g. a microwave oven.

In accordance with a third aspect, there is provided a locking system comprising the locking arrangement or galley insert and further comprising the second communicator. The locking system of the third aspect may comprise any of the features of the first and second aspects.

The second communicator may be comprised in a galley unit. The galley unit may comprise a second connector for connecting the galley unit to the galley assembly.

In accordance with a fourth aspect, there is provided a galley system comprising the locking system, a galley assembly and a galley insert. The galley system of the fourth aspect may comprise any of the features of the first to third aspects.

The galley system may comprise an aperture of receiving a pin to lock the galley insert to the galley assembly.

The galley system may comprise a rail. The aperture may be formed in the rail.

In accordance with a fifth aspect, there is provided a method comprising sensing, at a sensor, that a galley insert has been received by a galley assembly; and locking the galley insert to the galley assembly.

The method may comprise any of the features and/or functional steps described above with respect to the first to fourth aspects.

### BRIEF DESCRIPTION OF THE DRAWINGS

Embodiments will now be described, by way of example only, with reference to the accompanying drawings in which:

FIG. 1 shows a perspective drawing of a galley system;

FIG. 2 shows a schematic of a locking system;

FIG. 3 shows a front drawing of a locking arrangement; and

FIG. 4 shows a method.

### DETAILED DESCRIPTION

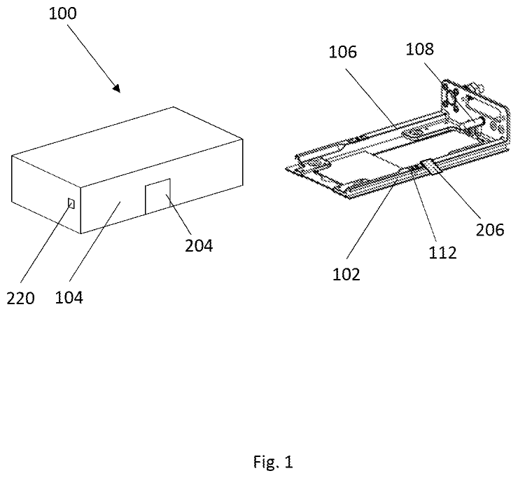

Referring to FIG. 1, there is a shown a galley system 100 for an aircraft. The galley system 100 comprises a galley assembly 102 and a galley insert 104. In the present example, the galley insert 104 is a cooking appliance. The galley insert 104 is a beverage maker e.g. a coffee maker. In other examples, the galley insert 104 is a different type of appliance. The galley insert 104 is not intended to be removed from the galley assembly 102 during flight, but may be removed, for example for servicing or replacement, when the aircraft is stationary.

The galley assembly 102 comprises rails 106 for receiving the galley insert 104 and maintaining the galley insert 104 in a fixed position relative to the aircraft during flight. The galley assembly 102 forms a part of a galley, including a frame defining a cavity (not shown) containing the rail system 106, with the galley insert 104 received in the cavity in use. When the galley insert 104 is received by the galley assembly 102, the galley insert 104 sits on top of the rails 106. The galley assembly 102 is configured to supply power to the galley insert 104 via connectors 108.

As described in more detail below, the galley system 100 comprises a locking system 200. The locking system 200 comprises a locking arrangement 202, which in the present example is mounted to the galley insert 104. In other examples the locking arrangement 202 or some of its components may be mounted to other components of the galley system 100. In the present example the locking arrangement 202 is comprised in an insert unit 204. The insert unit 204 is mounted to a side of the galley insert 104.

The locking system 200 comprises further features in the galley assembly 102. These include features in a galley unit 206. In other examples the further features may be in other components of the galley system 100.

The galley assembly 102 further comprises a galley locking component 112 for locking the galley assembly 102 to the galley insert 104, as described below. In the present example the locking component 112 is an aperture 112 configured to receive a pin.

The locking component 112 is positioned on the galley assembly 102 such that it aligns with the insert unit 204 when the galley insert 104 is received by the galley assembly 102. The galley unit 206 is positioned on the galley assembly 102 such that it aligns with the insert unit 204 when the galley insert 104 is received by the galley assembly 102.

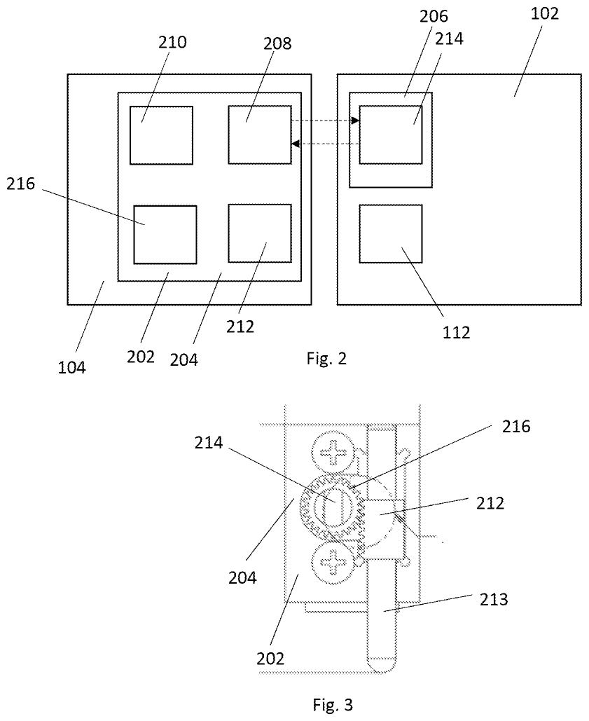

FIG. 2 shows the locking system 200. As described above, the locking system 200 comprises the locking arrangement 202, which is comprised in the insert unit 204 of the galley insert 104. The locking system 200 further comprises the galley unit 206 and the locking component 112 of the galley assembly 102.

The locking arrangement 202 comprises a sensor 208. The locking arrangement 202 comprises a controller 210. The locking arrangement 202 comprises a lock 212.

The locking system 200 comprises a user controllable element 220. The user controllable element 220 is a button. The user controllable element 220 is positioned on a front surface of the galley insert 104, such that the user controllable element 220 is accessible to a user when the galley insert 104 is received by the galley assembly 106.

The controller 210 is in data communication with the sensor 208, the lock 212 and the user controllable element 220.

In the present example the sensor 208 comprises a first communicator and the galley unit 206 comprises a second communicator 214. In other examples, the first communicator and the second communicator 214 may be reversed (i.e. with the first communicator on the galley and the second communicator on the galley insert). In this example, the first communicator is an active near field communication communicator. The second communicator is a passive near field communication communicator. The second communicator 214 is positioned on the galley assembly 102 such that it aligns with the first communicator when the galley insert 104 is received by the galley assembly 102

FIG. 3 shows the lock 212 of the insert unit 204 in more detail. The lock 212 comprises a pin 213. The lock 212 comprises an actuator 214. The actuator 214 is an electromagnetic actuator. The actuator 214 is a motor. The lock 212 comprises a gear device 216. The gear device 216 is configured to convert rotational movement from the actuator to linear movement of the pin 212.

The pin 212 is movable (in this example, by sliding) between locked position, in which the pin 212 is received by the aperture 112 to lock the galley insert 104 to the galley assembly 102, and an unlocked position, in which the pin 212 is not received by the aperture 112. In use, the pin 212 extends downwardly along the side of the galley insert 104.

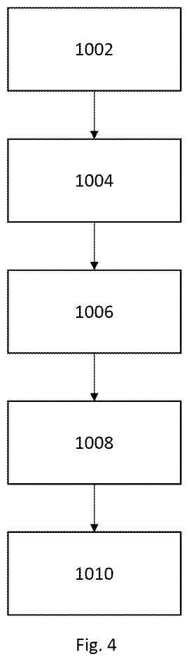

FIG. 4 shows a method 1000 of operation of the galley system 100. The method 1000 comprises a galley insert receiving step 1002, a sensing step 1004, a locking step 1006, a user control step 1008, an unlocking step 1010 and a galley insert removal step 1012.

In the galley insert receiving step 1002, the galley insert 104 is inserted into the galley assembly 102 by the user.

In the sensing step, when the galley insert 104 is received by the galley assembly 102, the first communicator 208 of the sensor 208 aligns with the second communicator 214 of the galley assembly 102, and the first communicator 208 transmits a first signal to the second communicator 214. The second communicator 214 receives the first signal. In response to receiving the first signal, the second communicator 214 transmits a second signal to the first communicator 208. The first communicator 208 receives the second signal. In response to the second signal being received, the sensor 208 transmits a galley insert received signal to the controller 210.

It will be understood that the first communicator 208 periodically transmits the first signal regardless of whether the galley insert 104 is received by the galley assembly 102. When the galley insert 104 is not received by the galley assembly 102, the first signal is not received by the second communicator 214 due to the second communicator 214 being too far from the first communicator 208. This means that the second communicator 214 does not transmit the second signal, and the second signal is not received by the first communicator 208. In the event that no second signal is received, the galley insert received signal is not transmitted to the controller 210.

In the locking step 1006, in response to receiving the galley insert received signal, the controller 210 controls the lock to lock the galley insert 104 to the galley assembly 102. In order to control the lock to lock the galley insert 104 to the galley assembly 102, the controller 210 sends a signal to the actuator 214 to cause the actuator 214 to move the pin 212 to the locked position. The actuator 214 rotates, with the gear device 216 in turn rotating to cause the pin 212 to slide from the unlocked position to the locked position. The pin 212 is received by the aperture 112, with the pin 212 and the aperture together locking the galley insert 104 to the galley assembly 102. In use the galley insert 104 may remain locked to the galley assembly 102 for the entirety of the aircraft's flight and in some examples for a plurality of flights.

In the user control step 1008, the user actuates the user controllable element 220 (e.g. by pressing the button). The user controllable element 220 sends an unlock signal to the controller 210.

In the unlocking step 1010, in response to receiving the unlock signal, the controller 210 controls the lock to unlock the galley insert 104 from the galley assembly 102. In order to control the lock to unlock the galley insert 104 from the galley assembly 102, the controller 210 sends a signal to the actuator 214 to cause the actuator 214 to move the pin 212 to the unlocked position. The actuator 214 rotates, with the gear device 216 in turn rotating to cause the pin 212 to slide from the locked position to the unlocked position. The pin 212 is not received by the aperture 112. The galley insert 104 may then be removed from the galley assembly 102, for example for maintenance or replacement when the aircraft is not in flight.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A locking arrangement for an aircraft galley system, the locking arrangement comprising a sensor and a controller, wherein the sensor is configured to determine when a galley insert has been received by a galley assembly and the controller is configured to control a lock to lock the galley insert to the galley assembly in response to the galley insert being received by the galley assembly.

2. The locking arrangement according to claim 1, wherein the sensor comprises a first communicator configured to determine that the first communicator is within proximity of a second communicator to determine that the galley insert has been received by the galley assembly.

3. The locking arrangement according to claim 2, wherein the first communicator is a near-field communicator.

4. The locking arrangement according to claim 1 and comprising the lock.

5. The locking arrangement according to claim 4, wherein the lock comprises a pin, the pin movable into a locked position wherein the pin is received in an aperture of the galley assembly to lock the galley insert to the galley assembly.

6. The locking arrangement according to claim 5, wherein the lock comprises an actuator for moving the pin into the locked position.

7. The locking arrangement according to claim 1 and comprising a user controllable element, the user controllable element actuatable to unlock the galley insert from the galley assembly.

8. The locking arrangement according to claim 1, wherein the locking arrangement is comprised in an insert unit.

9. A galley insert comprising the locking arrangement of claim 1.

10. The galley insert according to claim 9, wherein the galley insert is a cooking appliance.

11. A locking system comprising the locking arrangement of claim 2.

12. A locking system comprising the galley insert of claim 10 and further comprising the second communicator.

13. The locking system according to claim 12, wherein the second communicator is comprised in a galley unit.

14. A galley system comprising a galley assembly, the galley insert and the locking system according to claim 12.

15. The galley system according to claim 14 and comprising an aperture for receiving a pin to lock the galley insert to the galley assembly.

16. A method comprising:
sensing, at a sensor, that a galley insert has been received by a galley assembly; and
locking the galley insert to the galley assembly.
